(19) United States
(12) Patent Application Publication
(10) Pub. No.: US 2026/0355904 A1
(43) Pub. Date: Nov. 12, 2026

(54) HEATED HANDLE AND HOSE FOR DRY ICE BLASTING SYSTEM

(71) Applicant: Nu-Ice Age, Inc., Clarklake, MI (US)

(72) Inventors: Edward L. Cooper, Clarklake, MI (US); Steven J. Hayes, Addison, MI (US)

(21) Appl. No.: 19/134,371

(22) PCT Filed: Dec. 6, 2023
(86) PCT No.: PCT/US2023/082633

§ 371 Date: May 30, 2025

Related U.S. Application Data
(60) Provisional application No. 63/430,764, filed on Dec. 7, 2022.

(51) Int. Cl. B24C 5/02; B05B 1/24; B05B 9/00; B05B 15/63; B24C 1/00

(52) U.S. Cl. CPC B24C 5/02; B05B 1/24; B05B 9/005; B05B 15/63; B24C 1/003

(57) ABSTRACT

A system for providing heat to a handle of an ice blasting system includes a handle, a conduit extending through the handle for the conveying the ice through the handle, and a fluid coil that provides heated air into a cavity of the handle. The heated air enters the handle at an inlet end and flows through open space defined within the handle, and exits through a vent at the outlet end. The conduit is supported by a plurality of ribs that extend partially into the cavity of the handle. The air flows around the ribs in a serpentine path through the cavity. The heated air is provided by a fluid coil that wraps around a hose that supplies the ice. The handle includes a trigger and switch, with a signal cable from the switch extending through the fluid coil, or outside of the fluid coil.

### FIELD

This disclosure relates to the field of dry ice blast cleaning systems. More particularly, the present disclosure relates to a dry ice blast cleaning system having a dry ice feed apparatus and a method for feeding dry ice pieces within a dry ice blast cleaning system. More particularly, the present invention relates to a dry ice blast cleaning system having a heated handle.

### BACKGROUND

The statements in this section merely provide background information related to the present disclosure and may not constitute prior art.

The use of dry ice for blast cleaning is well known in the art. In dry ice blast cleaning systems, pieces of dry ice (solidified Carbon Dioxide, CO2) are drawn into a fluid stream (typically compressed air) and moved through a blast gun. The pieces of dry ice are entrained into the gas stream and propelled out of the gun to impact against the surface to be cleaned. After the dry ice pieces collide with the surface, the dry ice pieces sublimate into gaseous CO2 and become part of the ambient atmosphere. Generally, the only remaining residue from this process is the removed surface debris.

One issue with dry ice blast systems is the inherent low temperatures encountered during operation of the system. The operator of the system may perform the dry ice blasting operation manually by manipulating the spray of the pieces via the use of a handle through which the dry ice pieces are conveyed and expelled, such that handle becomes cold during operation.

There remains a need for a dry ice blast cleaning system which is comfortable and easy to operate.

### SUMMARY

In one aspect, a system for providing hot air to a handle of a dry ice blasting system is provided, the system comprising: a hose having an inlet end configured for connection to a source of dry ice material and an outlet end configured to provide dry ice material therefrom; a handle having an inlet end connected to the outlet end of the hose, the handle including a conduit extending from the inlet end of the handle to an outlet end of the handle, wherein the conduit receives the dry ice material from the hose and conveys the dry ice to the outlet end of the housing; a cavity defined within the handle, wherein the cavity is fluidly isolated from the conduit and defines an open space extending from the inlet end to the outlet end of the handle; a fluid coil having an inlet end configured for connection to a source of hot air and an outlet end connected to an inlet port of the handle in fluid communication with the cavity; a vent defined through the outlet end of the handle, wherein the vent is fluidly connected to the cavity and vents the cavity; wherein hot air flows through the fluid coil, into the cavity, and out of the vent to heat the handle.

In one aspect, the fluid coil wraps around the hose and heated air flowing through the fluid coil heats the hose.

In one aspect, the fluid coil includes a signal cable extending therethrough, wherein the hot air flows around the signal cable.

In one aspect, the handle include a switch disposed within the housing, wherein the switch provides a signal in response to actuation of a trigger of the handle, wherein a signal cable extends through the coil and provides an actuation signal from the handle.

In one aspect, the system includes a signal cable extending around the hose, wherein the signal cable is outside of the fluid coil and the heated air flows through the coil separate from the signal cable.

In one aspect, the handle include a switch disposed within the housing, wherein the switch provides a signal in response to actuation of a trigger of the handle, wherein a signal cable extends from the housing and around the hose, wherein the signal cable is disposed outside of the fluid coil.

In one aspect, a coil fitting is provided between the coil and the housing and a cable fitting is provided between the signal cable and the housing, wherein the coil fitting and the cable fitting are separate.

In one aspect, the handle includes a plurality of ribs extending within the channel, wherein the ribs support the conduit within the cavity.

In one aspect, the ribs extend partially into the cavity, defining an empty space at a corresponding location lateral to the rib, such that air is blocked by the rib and flows through the empty space at a given location.

In one aspect, the ribs are staggered along a length of the cavity and define a serpentine flow path through the cavity.

In one aspect, the handle is formed by first and second shells.

In one aspect, the ribs are disposed on each of the first and second shells, where portions of each rib are disposed on opposing locations of each shell.

In another aspect, a method of providing heat to a handle of an ice-blasting system is provided, the method comprising: providing heated air through a tubular member toward a handle of an ice-blasting system; conveying the heated air into a cavity of the handle at an inlet end thereof; routing the heated air within the handle and through the cavity past an outer surface of a conduit extending between the inlet end and an outlet end of the handle; heating the handle at an outer surface thereof; conveying the heated air out of a vent at the outlet end of the handle.

In one aspect, the method includes conveying ice through the conduit, wherein the heated air is fluidically isolated from the ice being conveyed through the conduit.

In one aspect, the handle include a plurality of ribs that support the conduit within the cavity, wherein the heated air flows past the ribs in a serpentine path defined by a staggered arrangement of the ribs.

In one aspect, the ribs extend partially into the cavity, leaving an empty space through which the heated air is routed.

In one aspect, the ice is conveyed through a hose attached to the inlet end of the handle, where the tubular member conveying the heated air coils around the hose.

In one aspect, the handle includes a trigger and a switch, wherein actuating the switch by the trigger causes the ice to be conveyed and the heated air to be provided through the tubular member.

In one aspect, a signal cable extending from the switch extends within the tubular member, and the heated air flows through the tubular member around the signal cable.

In one aspect, a signal cable extending from the switch extends along with the tubular member outside of the tubular member.

This summary is provided merely to introduce certain concepts and not to identify key or essential features of the claimed subject matter. The substance and advantages of the present invention will become increasingly apparent by reference to the following drawings and the description.

### BRIEF DESCRIPTION OF THE DRAWINGS

One or more embodiments will now be described, by way of example, with reference to the accompanying drawings, in which:

FIG. 1 is a perspective view of a dry ice blast system having a heating tube for warming the hose and handle thereof;

FIG. 2 is an exploded view of the system;

FIG. 3 is an enlarged exploded view of the handle of the system;

FIG. 4A is another exploded view of the handle of the system;

FIG. 4B is an exploded view of the fittings between the hose and handle of the system;

FIG. 5 is a side view of the system;

FIG. 6 is a side view of the handle of the system illustrating a path of warm air flowing through the handle;

FIG. 7 is a perspective view of an alternative aspect of the handle, signal cable, and fluid coil of the system; and

FIG. 8 is a side view of the system of FIG. 7.

### DETAILED DESCRIPTION

Various embodiments of the present invention will be described in detail with reference to the drawings, where like reference numerals represent like parts and assemblies throughout the several views. Reference to various embodiments does not limit the scope of the invention. Additionally, any examples set forth in this specification are not intended to be limiting and merely set forth some of the many possible embodiments for the claimed invention.

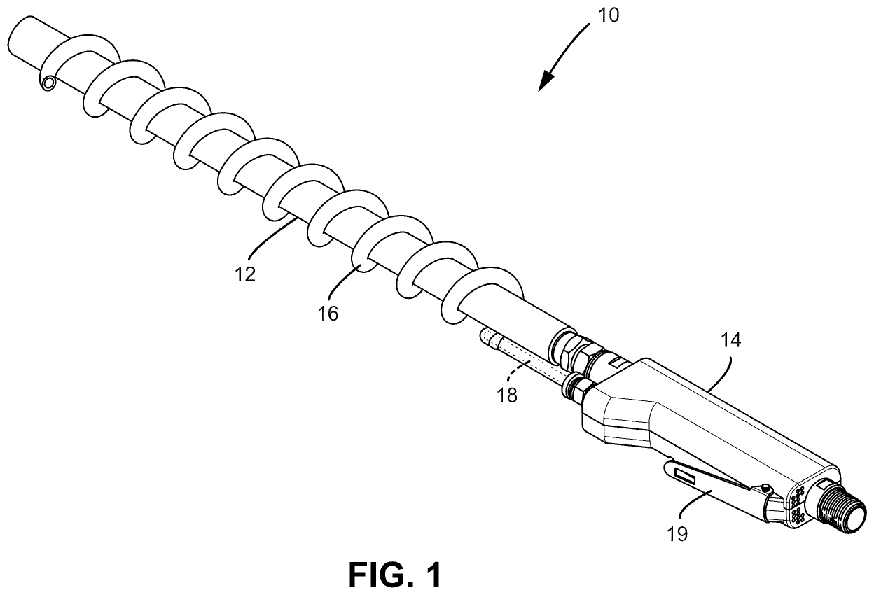

Referring now to the drawings, wherein the depictions are for the purpose of illustrating certain one embodiments only and not for the purpose of limiting the same, FIG. 1 shows a dry ice delivery system 10 including a hose 12 connected to a handle assembly 14. The hose 12 is configured for use with a dry ice blast system, such as the system disclosed in co-owned U.S. Pat. No. 9,700,989, filed Mar. 12, 2015, issued Jul. 11, 2017, titled “Dry Ice Blast Cleaning System and Method for Operating the Same,” the entire content of which is incorporated by reference in its entirety.

The system 10, in one aspect is configured to be attached to a hopper (not shown) having the dry ice nuggets or other size/form of dry ice material. The system 10 may also be attached to various other types of dry ice supply. The system 10 may be semi-automated such that actuation via the handle 14 will cause the system to provide and force the dry ice through the system, such as by suspending the dry ice material in a pressurized air stream.

The hose 12 is generally flexible and has a sufficiently wide diameter to convey the dry ice material suspended in the airstream. The flexibility of the hose 12 is selected so as to be sufficiently manipulated by an operator of the system, but robust enough to withstand the low internal temperature of the dry ice material being conveyed internally therethrough.

As dry ice reaches the handle 14, the dry ice will be conveyed through the handle 14 and expelled from a nozzle or nozzle assembly (not shown), which may be an elongate tube or the like attached to the outlet end of the handle 14.

In addition to the house 12 and the handle assembly 14, the system 10 further includes a heated fluid coil 16, which is sized and arranged to convey heated air through the interior of the fluid coil from a source of heated air (not shown) to and through the handle 14, thereby providing heat to the handle 14. In one aspect, the temperature of the air is selected to be hot enough to heat the exterior of the handle 14 to a comfortable temperature that is within a desirable range for the operator.

The handle 14 defines a hollow space therein through which the heated air is conveyed, isolated from the dry ice material, and from which the heated/hot air is exhausted at the outlet end of the handle 14.

The fluid coil 16 wraps around the hose 12, and is also flexible to flex along with the hose 12 as a unit. The fluid coil 16, in addition to conveying the heated air, also provides a conduit for a signal cable 18 extending from a switch in the handle 14 to a controller of the system (not shown) that signals an on/off state as controlled by the user via the handle 14. Thus, the trigger of the handle 14 provides the semi-automatic control via the signal.

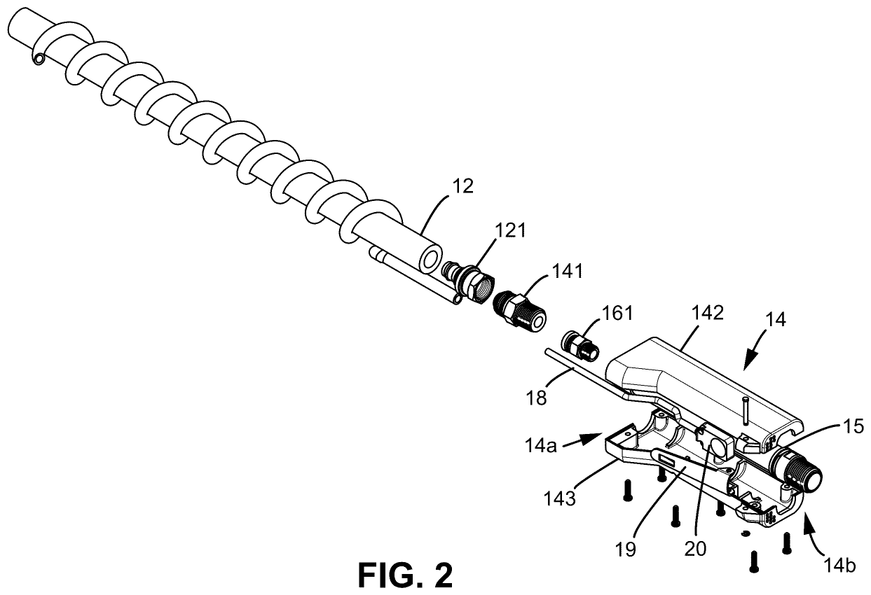

FIG. 2 illustrates the system 10 in an exploded view, and includes hose 12, hose fitting 121, handle fitting 141, and coil fitting 161. Handle 14 further includes first and second shells 142, 143 that define the handle shape, and internal pipe 15 that extends through the handle 14 from the inlet end 14a to the outlet end 14b and that isolates the dry ice from the interior cavity defined by the shells 142, 143. The handle 14 further includes trigger 19 pivotally mounted and biased away from the handle to an off position. Handle 14 includes, within the cavity, switch 20 that is operatively associated with the trigger 19, such that actuation of the trigger 19 causes the switch 20 to transmit a signal to the controller to activate the system and convey the dry ice material therethrough.

In one aspect, the switch 20 is a proximity switch, such as an inductive sensor. In another aspect, the switch 20 could be another proximity sensor like a hall effect sensor. Other switch types may also be used.

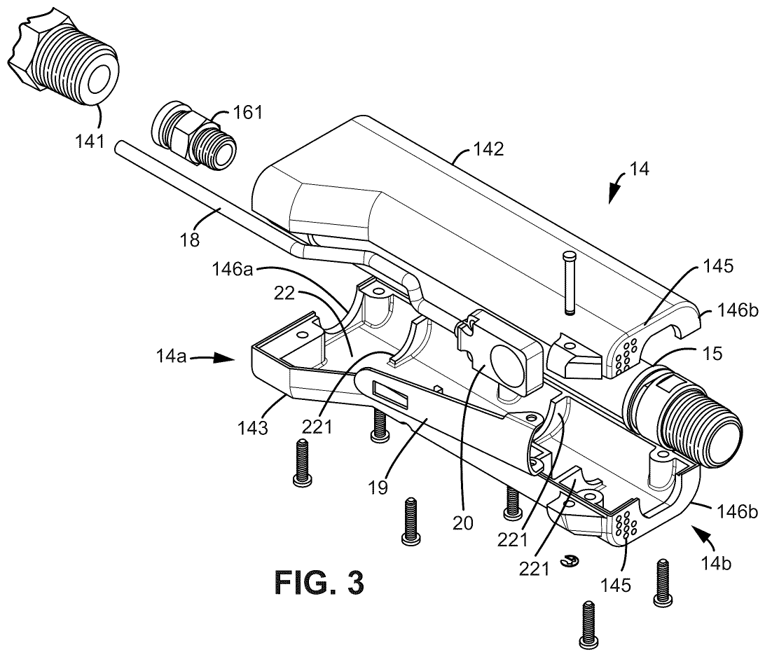

FIG. 3 illustrates an enlarged section of the exploded view and provides further detail of the handle. The handle 14 defines cavity 22 therein, which includes a plurality of ribs 221 disposed in the cavity 22 alternating between the top and the bottom side (with corresponding ribs on the opposite shell) to define a curved channel that supports and holds the internal pipe 15. Switch 20, having signal cable 18 extending rearwardly therefrom toward the inlet end 14a, is housed within a section of the cavity 22 adjacent the trigger 19.

The handle 14 further includes, at the outlet end, a plurality of vent holes 145 (defining a vent section) that extend through the shells 142, 143. Thus, the heated air being conveyed through the cavity from the inlet end 14a toward the outlet end 14b will be expelled from the cavity 22 via the vent holes 145.

The shells 142, 143 each include a cutout 146a, 146b at the inlet and outlet end, respectively, that is configured to receive a cooperative structure of the internal pipe 15 to secure the internal pipe 15. As shown in FIG. 3, both the pipe 15 and the cutouts 146b at the outlet end have flats formed thereon to maintain a rotational position. The outlet end of the pipe 15 is threaded and configured to attach to a desired outlet nozzle or extension member (not shown).

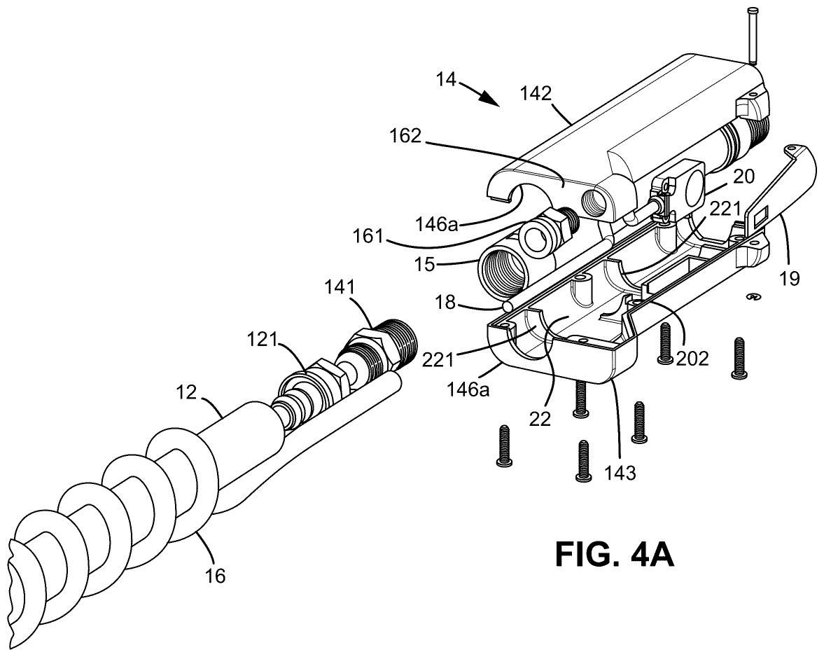

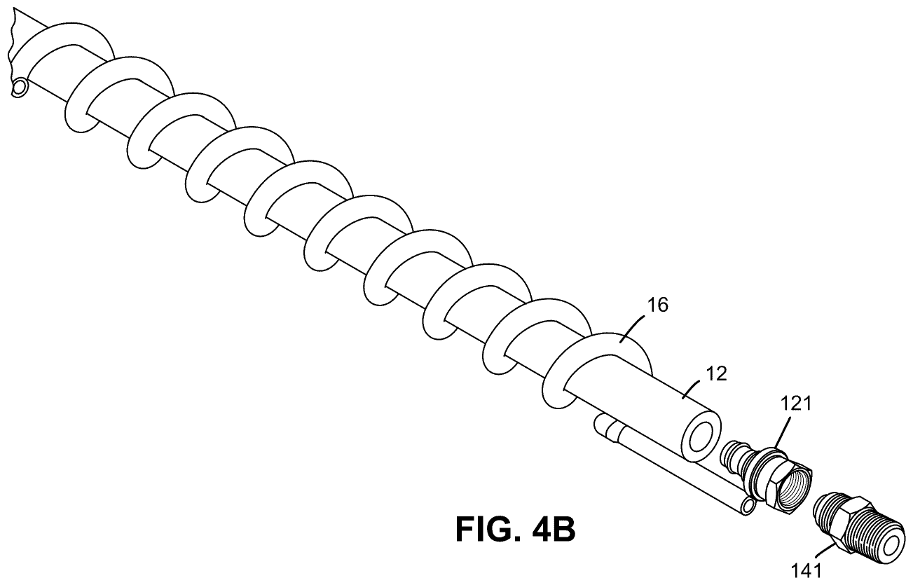

FIG. 4A illustrates the inlet side of the exploded view of the handle 14 more clearly. As shown in FIG. 4A, a housing section 202 for the switch is shown formed in the handle 14. A threaded inlet 162 for the coil fitting 161 is shown formed in shell 142. The signal cable 18 extends through the fitting 161 and through the coil 16 attached thereto. The fitting 161 inner diameter is sized larger than the signal cable 18 such that the hot air will flow around the signal cable 18 through the fitting 161.

The cutouts 146a of the housing are rounded, and the inlet end of the pipe 15 includes a stepped diameter for axial positioning, with the inlet end of the pipe 15 extending rearwardly from the inlet end of the housing 14.

The cable 18 extends from the fitting 161 and through the coil 16 toward and to the controller (not shown). Similar to the fitting 161, the coil 16 has an inner diameter sized larger than the cable 18, such that the hot air provided through the coil will flow around and past the cable 18 and into the cavity 22 of the handle 14. The size of the coil 16 and its inner diameter relative to the size of the signal cable 18 can be adjusted to ensure sufficient fluid flow. For instance, if the signal cable has a larger diameter, a coil with a larger inner diameter can be used.

The pipe 15, at its inlet end, includes internal threading, sized and configured to mate with external threading of the outlet end of handle fitting 141. Handle fitting 141 includes external threads at both inlet and outlet ends thereof. The external threading mates with the internal threading at the outlet end of hose fitting 121. The inlet end of hose fitting 121 may include ribs or ridges and may be press-fit into the outlet end of the hose 12. FIG. 4B illustrates another view of the fittings 121 and 141 relative to hose 12. It will be appreciated that other connection types and/or threading arrangements could also be used.

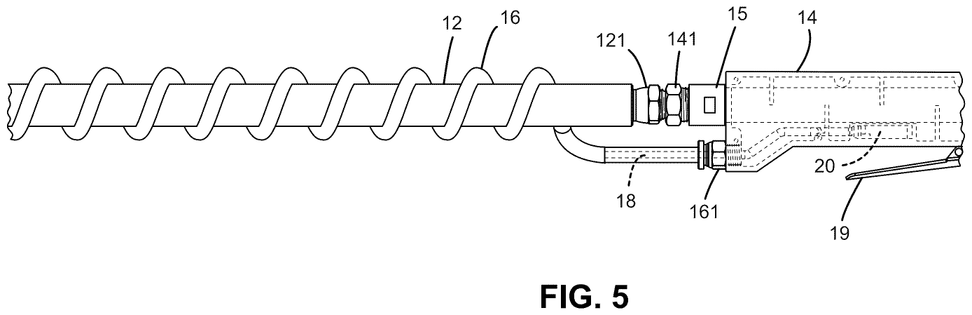

The assembly of the hose 12, fitting 121, fitting 141, pipe 15, and handle 14 is shown in the side view of FIG. 5. FIG. 5 also illustrates fitting 161 connected between coil 16 and handle 14, with signal cable 18 extending therethrough.

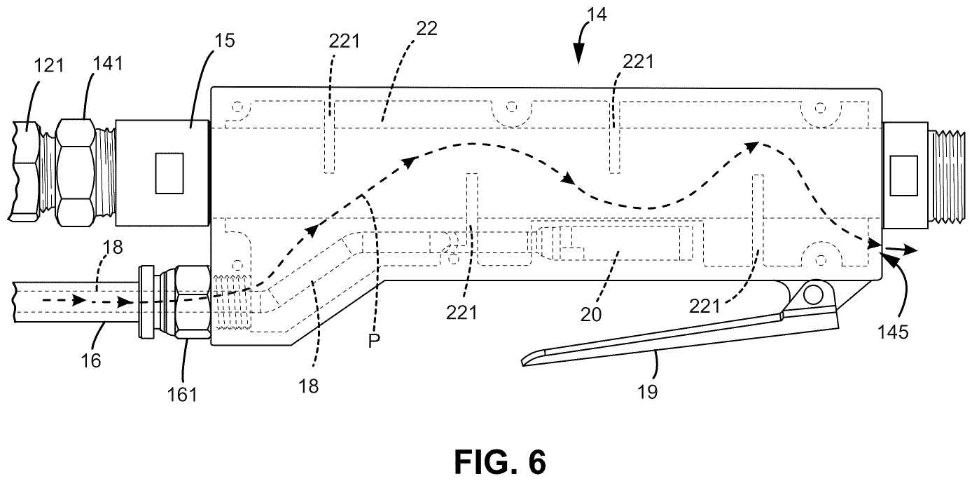

FIG. 6 illustrates a path P of the hot air that is conveyed through the cavity 22 of the handle 14. As shown, the air flows through the cavity 22 and around ribs 221 in a wavy, serpentine pattern. The air will flow around the outside of the tube 15 through the open space in the cavity 22 that surrounds the tube, and exit through the holes 145 at the outlet end of the handle 14. The arrangement of the ribs 221 shown is one example, but it will be appreciated that other rib arrangements could also be used, including additional ribs or fewer ribs. As shown, the ribs 221 alternate between extending partially from the upper side or the lower side into the cavity 22. However, adjacent ribs 221 may extend from the same side, depending on the overall shape of the handle or the needs of the user. The ribs 221 extend partially into the cavity 22 from one side or the other, such that open space is provided lengthwise through the handle cavity 22. In one aspect, the ribs 221 can be provided on of the shell pieces forming the handle, but on the other in the same location, thereby providing the open space, rather than being in matching locations on opposing shells. In this case, the ribs 221 can extend fully from the top to the bottom of the handle shape, because the left/right side of the cavity 22 will be open.

The provision of hot air through the coil 16 performs multiple functions. In one aspect, the hot air keeps the hose 12 warm to limit and/or prevent the hose from breaking or cracking due to cold temperature. The hot air similarly keeps the signal cable 18 within a desirable operating range. Of course, the hot air also flows through the handle 14 and warms the outside of the handle 14 to improve comfort of the operator and prolonging a usable period of time available to operator.

The hot air may be provided and controlled in a manner similar to the dry ice material being controlled by the on/off function of the trigger 19. In another aspect, the hot air may be controlled via a separate switch, to maintain the signal cable 18, coil 16, and hose 12 at a warm temperature even when dry ice material is not being conveyed. The additional switch/trigger may be arranged similar to trigger 19 and switch 20, with the corresponding signal cable being provided through the coil 16.

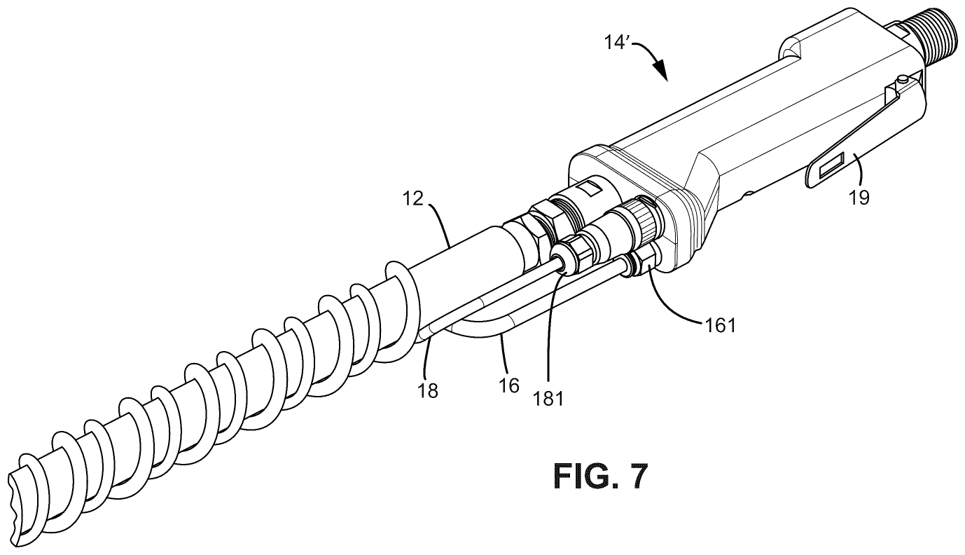

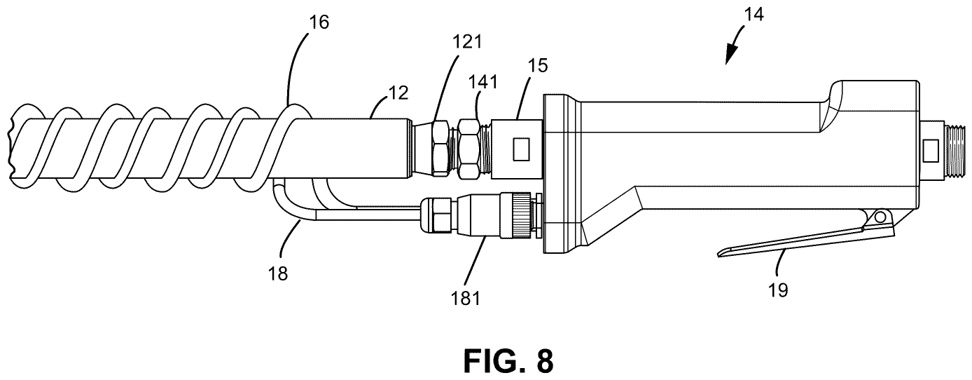

In another aspect, shown in FIGS. 7 and 8, and alternative handle 14′ is shown, having a ridge formed at the outlet end thereof for additional handling support by the operator. The handle shape shown in FIGS. 7 and 8 may be used with the earlier discussed embodiment. The handle 14′ further includes a protrusion or rib at the inlet end to improve the operator grip on the handle 14′. Additionally, the signal cable 18 is shown in this aspect outside of the coil 16, wrapping around the hose 12 in a manner similar to the coil 16. In this aspect, hot air flowing through coil 16 does not directly heat or contact the signal cable 18, and the flow area through the coil 16 is increased relative to the previously described arrangement.

In this aspect, a separate fitting 181 for the signal cable is provided, which is threaded into the housing shell similar to fitting 161. Hot air passes through fitting 161 into the cavity 22, as previously described. The cable 18 is routed through the interior of the cavity 22 from the switch 20 and into fitting 181.

It will be appreciated that one or more of the aspects of FIGS. 7 and 8 may be applied to the system shown in FIGS. 1-6, and vice versa. For example, the shape of handle 14 may be applied to FIGS. 1-6 without using the separated signal cable and additional fitting. Or, the separately arranged signal cable and fitting may be applied to the housing 14 of FIGS. 1-6 without altering the housing shape.

It will be appreciated that other assembly stack-ups can also be used to provide heated air around the hose 12 and through the handle 14 and remain within the spirit and scope of the present disclosure, and the present disclose is not limited to the embodiment disclosed herein. Various materials can be used for the components described herein. The handle shells may be injection molded plastic. The fittings may be stainless steel. However, other materials may also be used.

The above system 10 may be used in a variety of dry ice blasting systems, including various types of storage containers, dry ice piece size, etc. The hot air may be provided from a variety of air sources. For instance, cold pressurized air can be heated prior to being introduced into the system, or pre-heated air could be drawn into and pumped through the system.

In accordance with the above disclosure, the present disclosure also provides a method for using the system 10 to provide heat to the handle.

In one aspect, a method of providing heat to a handle of an ice-blasting system is provided, the method comprising: providing heated air through a tubular member toward a handle of an ice-blasting system; conveying the heated air into a cavity of the handle at an inlet end thereof; routing the heated air within the handle and through the cavity past an outer surface of a conduit extending between the inlet end and an outlet end of the handle; heating the handle at an outer surface thereof; conveying the heated air out of a vent at the outlet end of the handle.

In one aspect, the method includes conveying ice through the conduit, wherein the heated air is fluidically isolated from the ice being conveyed through the conduit.

In one aspect, the handle include a plurality of ribs that support the conduit within the cavity, wherein the heated air flows past the ribs in a serpentine path defined by a staggered arrangement of the ribs.

In one aspect, the ribs extend partially into the cavity, leaving an empty space through which the heated air is routed.

In one aspect, the ice is conveyed through a hose attached to the inlet end of the handle, where the tubular member conveying the heated air coils around the hose.

In one aspect, the handle includes a trigger and a switch, wherein actuating the switch by the trigger causes the ice to be conveyed and the heated air to be provided through the tubular member.

In one aspect, a signal cable extending from the switch extends within the tubular member, and the heated air flows through the tubular member around the signal cable.

In one aspect, a signal cable extending from the switch extends along with the tubular member outside of the tubular member.

It will be appreciated that the above method embodiment may be further tailored according to the features and functionality of the system 10 as described above, including method steps associated with the above-described system 10.

In the foregoing description, various features of the present invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated by reference herein in their entirety, with each claim standing on its own as a separate embodiment of the present invention.

It is intended that the foregoing description be only illustrative of the present invention and that the present invention be limited only by the hereinafter appended claims.

What is claimed is:

1. A system for providing hot air to a handle of a dry ice blasting system, the system comprising:
a hose having an inlet end configured for connection to a source of dry ice material and an outlet end configured to provide dry ice material therefrom;
a handle having an inlet end connected to the outlet end of the hose, the handle including a conduit extending from the inlet end of the handle to an outlet end of the handle, wherein the conduit receives the dry ice material from the hose and conveys the dry ice to the outlet end of the housing;
a cavity defined within the handle, wherein the cavity is fluidly isolated from the conduit and defines an open space extending from the inlet end to the outlet end of the handle;
a fluid coil having an inlet end configured for connection to a source of heated air and an outlet end connected to an inlet port of the handle in fluid communication with the cavity;
a vent defined through the outlet end of the handle, wherein the vent is fluidly connected to the cavity and vents the cavity;
wherein heated air flows through the fluid coil, into the cavity, and out of the vent to heat the handle.

2. The system of claim 1, wherein the fluid coil wraps around the hose and heated air flowing through the fluid coil heats the hose.

3. The system of claim 1, wherein the fluid coil includes a signal cable extending therethrough, wherein the hot air flows around the signal cable.

4. The system of claim 1, wherein the handle include a switch disposed within the housing, wherein the switch provides a signal in response to actuation of a trigger of the handle, wherein a signal cable extends through the coil and provides an actuation signal from the handle.

5. The system of claim 1, wherein the system includes a signal cable extending around the hose, wherein the signal cable is outside of the fluid coil and the heated air flows through the coil separate from the signal cable.

6. The system of claim 1, wherein the handle include a switch disposed within the housing, wherein the switch provides a signal in response to actuation of a trigger of the handle, wherein a signal cable extends from the housing and around the hose, wherein the signal cable is disposed outside of the fluid coil.

7. The system of claim 6, wherein a coil fitting is provided between the coil and the housing and a cable fitting is provided between the signal cable and the housing, wherein the coil fitting and the cable fitting are separate.

8. The system of claim 1, wherein the handle includes a plurality of ribs extending within the channel, wherein the ribs support the conduit within the cavity.

9. The system of claim 8, wherein the ribs extend partially into the cavity, defining an empty space at a corresponding location lateral to the rib, such that air is blocked by the rib and flows through the empty space at a given location.

10. The system of claim 9, wherein the ribs are staggered along a length of the cavity and define a serpentine flow path through the cavity.

11. The system of claim 8, wherein the handle is formed by first and second shells.

12. The system of claim 11, wherein the ribs are disposed on each of the first and second shells, where portions of each rib are disposed on opposing locations of each shell.

13. A method of providing heat to a handle of an ice-blasting system, the method comprising:
providing heated air through a tubular member toward a handle of an ice-blasting system;
conveying the heated air into a cavity of the handle at an inlet end thereof;
routing the heated air within the handle and through the cavity past an outer surface of a conduit extending between the inlet end and an outlet end of the handle;
heating the handle at an outer surface thereof;
conveying the heated air out of a vent at the outlet end of the handle.

14. The method of claim 13, further comprising conveying ice through the conduit, wherein the heated air is fluidically isolated from the ice being conveyed through the conduit.

15. The method of claim 13, wherein the handle include a plurality of ribs that support the conduit within the cavity, wherein the heated air flows past the ribs in a serpentine path defined by a staggered arrangement of the ribs.

16. The method of claim 15, wherein the ribs extend partially into the cavity, leaving an empty space through which the heated air is routed.

17. The method of claim 13, wherein the ice is conveyed through a hose attached to the inlet end of the handle, where the tubular member conveying the heated air coils around the hose.

18. The method of claim 13, wherein the handle includes a trigger and a switch, wherein actuating the switch by the trigger causes the ice to be conveyed and the heated air to be provided through the tubular member.

19. The method of claim 18, wherein a signal cable extending from the switch extends within the tubular member, and the heated air flows through the tubular member around the signal cable.

20. The method of claim 18, wherein a signal cable extending from the switch extends along with the tubular member outside of the tubular member.
